(19) United States
(12) Patent Application Publication
(10) Pub. No.: US 2019/0056045 A1
(43) Pub. Date: Feb. 21, 2019

(54) SPIRAL BANDING

(71) Applicant: RodDoc LLC, Mays Landing, NJ (US)

(72) Inventor: Frank Dougherty, Mays Landing, NJ (US)

(73) Assignee: RodDoc LLC, Mays Landing, NJ (US)

(21) Appl. No.: 15/921,573

(22) Filed: Mar. 14, 2018

Related U.S. Application Data
(60) Provisional application No. 62/471,057, filed on Mar. 14, 2017.

(51) Int. Cl. F16L 9/00; E21B 17/00; F16L 15/00

(52) U.S. Cl. CPC F16L 9/00; E21B 17/042; F16L 15/00; E21B 17/00

(57) ABSTRACT

Various processes for the addition or build-up of material such as base metals or alloys onto tool joints and/or threads of drill pipe typically used in, but not limited to, the gas and oil industry are disclosed. In one example, a spiral delivery of material is described, as well as, a machine that delivers the material onto the tool joints and/or threads of drill pipe. Variables can be temperature used during pre-heat, application, inter-pass and/or post process, electrical current used (AC/DC), volts, amps, wire type and size, cooling process, width and depth of bead applied, rotation, and travel speed.

### CROSS-REFERENCE TO RELATED APPLICATIONS

This application claims the benefit of U.S. Provisional Application No. 62/471,057 filed on Mar. 14, 2017, the disclosure of which is incorporated herein by reference in its entirety.

### BACKGROUND

Hardbanding is a common process that uses welding wire and welding processes to repair or build up high friction areas of a tool or tool part. This is a process that is typically used in the oil and gas industry for use on drill pipes.

Drill pipes come in a variety of diameters and lengths. An example drill pipe may include a “male” or “pin” end, a “female” or “box” end, and a “shaft” that extends between the pin end and the box end. An interior portion of the box end is typically threaded. An exterior portion of the pin end is typically threaded for connection to a complementary box end of another pipe.

Pipes may be connected to form “strings,” which can be several hundred feet in length. The connecting area between two pipes may be referred to as a “tool joint.” The tool joint has a larger outer diameter than the rest of the pipe, which creates excessive wear on the joint area during routine operation. To combat the wear, hardbanding may be used on the tool joints. Initial hardbanding is typically done during the original manufacturing process of the pipe, though hardbanding may also be done post-production.

Until recently, post-production hardbanding was done with standard welding wire and tungsten carbide particles. The particles are put into a matrix either through Submerged Arc Welding (SAW) or Friction Stir Welding and applied to the pipe. Carbon particles tend to become abrasive projections, and the tungsten carbide hardbanding is not smooth. Though the tungsten carbide hardbanding may increase the life of the tool joint, the process typically shortens the life of the casing in which the drill pipe runs. Most current drilling activity takes place in cased holes and the abrasiveness of the tungsten carbide particles from the hardbanding process creates real, often catastrophic problems. Casing wear-through is when the drill pipe rotating inside of the casing grounds through the casing during drilling.

Additional background may be found in the following references: WO1994008747 “Drill pipe hardband removal and build up,” US20070209839 “System and Method for reducing wear in drill pipe sections,” and US20150252631 “Hardbanding methods and apparatus,” each of which is incorporated herein by reference.

### SUMMARY

Disclosed herein are methods and apparatus for applying hardbanding material to a workpiece, such as a drill pipe, for example, in a process that may be referred to as spiral banding. A spiral-banded drill pipe may include a pin end, a box end, and a shaft that extends between the pin end and the box end. The pin end may have a threaded tip that includes threading on an exterior surface of the pin end. The box end having a threaded tip that includes threading on an interior surface of the box end.

A first spiral band of welding material may be deposited on an exterior surface of the pin end. The first spiral band may be a continuous bead of welding material that is deposited on an exterior surface of the pin end, and spirals around a portion of the pin end. A second spiral band of welding material may be deposited on an exterior surface of the box end. The second spiral band may be a continuous bead of welding material that is deposited on an exterior surface of the box end, and spirals around a portion of the box end.

The pin end may be hollow, and the first spiral band deposited on an exterior surface of a portion of the pin end that has a constant outer diameter. The box end may be hollow, and the second spiral band deposited on an exterior surface of a portion of the box end that has a constant outer diameter.

The pin end may have a threaded tip having threading on an exterior surface of the pin end. The box end may have a threaded tip having threading on an interior surface of the box end. The threading on the interior surface of the box end may be complementary to the threading on the exterior surface of the pin end, such that the pin end of a first pipe may be screwed into the box end of a second, complementary pipe.

### BRIEF DESCRIPTION OF THE DRAWINGS

FIGS. 1A-1E depict an example drill pipe without hardbanding.

FIGS. 2A-2E depict an example drill pipe with axial hardbanding.

FIGS. 3A-3E depict an example drill pipe with longitudinal hardbanding.

FIGS. 4A-4E depict an example drill pipe with spiral banding.

FIGS. 5A-5C illustrate an example method and apparatus for spiral banding a drill pipe.

### DETAILED DESCRIPTION

The process of hardbanding may be described as a method for adding material to the outer surface of the box and/or pin end of drill pipes through the use of, for example, Metal Inert Gas (MIG) welding, Shielded Metal Arc (SMAW) welding, flux-cored welding, Plasma Arc (PAW) welding, using the rotation of the workpiece to measure the application of the material. Tungsten-electrode Inert Gas (TIG) can be used, however the tungsten particles can be abrasive for drill casing operations.

Gas metal arc welding (GMAW), sometimes referred to by its subtypes metal inert gas (MIG) welding, is a welding process in which an electric arc forms between a consumable electrode and the workpiece metal(s), which heats the workpiece metal(s), causing them to melt and join. Along with the wire electrode, a shielding gas (usually argon) feeds through the welding gun, which shields the process from contaminants in the air. A constant voltage DC power source is most commonly used with GMAW, but constant current systems, as well as AC power can be used.

Shielded metal arc welding (SMAW), also known as flux shielded arc welding or informally as stick welding, is a manual welding process that uses a consumable electrode coated in flux to lay the weld. An electric current, either AC or DC, is used to form an electric arc between the electrode and the metals to be joined. As the weld is laid, the flux coating of the electrode disintegrates, giving off vapors that serve as a shielding gas and providing a layer of slag, both of which protect the weld area from atmospheric contamination.

Plasma arc welding (PAW) is an arc welding process wherein an electric arc is formed between an electrode (which is usually but not always made of sintered tungsten) and the workpiece. By contrast to GTAW, in PAW, by positioning the electrode within the body of the torch, the plasma arc can be separated from the shielding gas. The plasma is then forced through a fine-bore copper nozzle that constricts the arc, and the plasma exits the orifice at high velocities (approaching the speed of sound) and a temperature approaching 28,000° C. (50,000° F.) or higher.

Arc plasma is the temporary state of a gas. The gas gets ionized after passage of electric current through it and it becomes a conductor of electricity. In an ionized state, atoms break into electrons (−) and ions (+), and the system contains a mixture of ions, electrons, and highly exited atoms. The degree of ionization may be between 1% and greater than 100%, i.e., double and triple degrees of ionization. Such states exist as more electrons are pulled from their orbits.

The temperature at which material is delivered is dependent upon the type or style of weld being utilized. The amount of material applied depends on a number of factors, such as type of workpiece metal, degree of wear, and desired thickness, for example. The material can be added using various techniques. A “weave bead” is one that is made with oscillations of the welding electrode which delivers the material. This technique is usually automated. A “stringer bead” is one that uses one continuous bead that runs parallel to the axis of the bead.

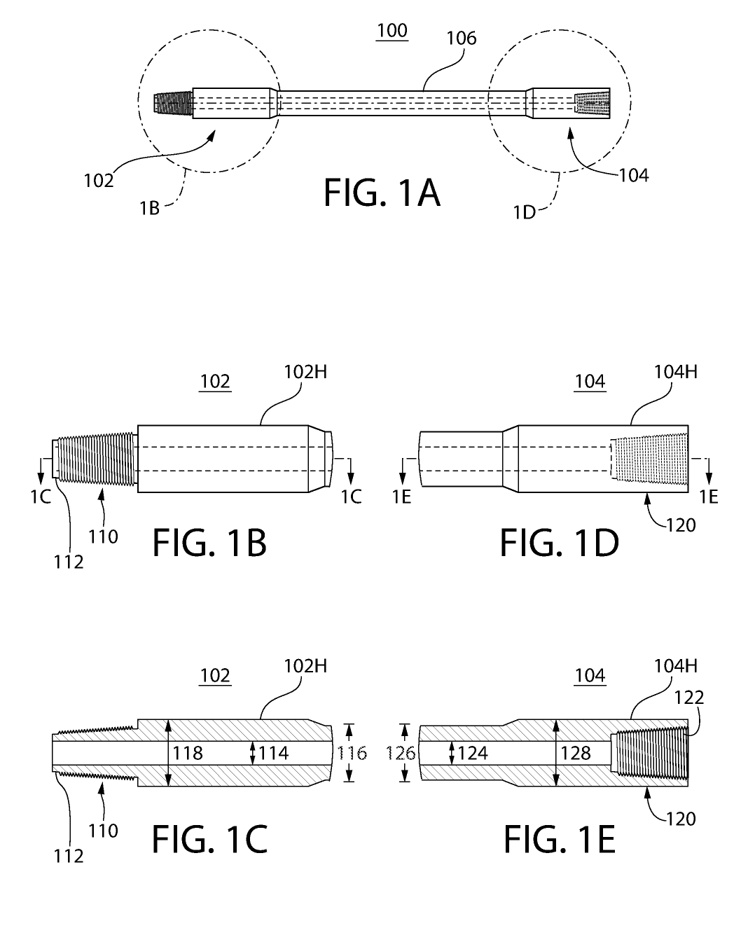

FIG. 1A depicts an example drill pipe 100 without hardbanding. As shown, the drill pipe 100 may include a pin end 102, a box end 104, and a shaft 106 that extends between the pin end 102 and the box end 104.

FIG. 1B depicts the pin end 102 of the drill pipe 100 depicted in FIG. 1A. FIG. 1C is a cross-sectional view of the pin end 102 depicted in FIG. 1B. As shown in FIGS. 1B and 1C, the pin end 102 may have a threaded tip 110. The threaded tip 110 may have threading on an exterior surface 112 of the pin end 102.

As shown in FIG. 1C, the pin end 102 may be hollow, and may have a constant inner diameter 114 and a varying outer diameter 116. A portion 102H of the pin end 102 may have a constant outer diameter 118.

FIG. 1D depicts the box end 104 of the drill pipe 100 depicted in FIG. 1A. FIG. 1E is a cross-sectional view of the box end 104 depicted in FIG. 1D. As shown in FIGS. 1D and 1E, the box end 104 may have a threaded tip 120. The threaded tip 120 may have threading on an interior surface 122 of the box end 104. The threading on the interior surface 122 of the box end tip 120 may be complementary to the threading on the exterior surface 112 of the pin end tip 110, such that the pin end 102 of a first pipe may be screwed into the box end 104 of a complementary second pipe.

As shown in FIG. 1E, the box end 104 may be hollow, and may have a constant inner diameter 124 and a varying outer diameter 126. A portion 104H of the box end 104 may have a constant outer diameter 128.

In a known process, which may be referred to herein as axial hardbanding, the material is applied in bands that are perpendicular to the length of the drill pipe. Typically, the bands are applied parallel to one another. The drill pipe may be mounted in such a way that allows for ease of rotation. The electrode may be placed in the desired starting area, and activated for one complete rotation. The electrode may then be deactivated and moved laterally, and then activated again for one complete rotation. This process is repeated until the entire area that is needed to be banded is complete.

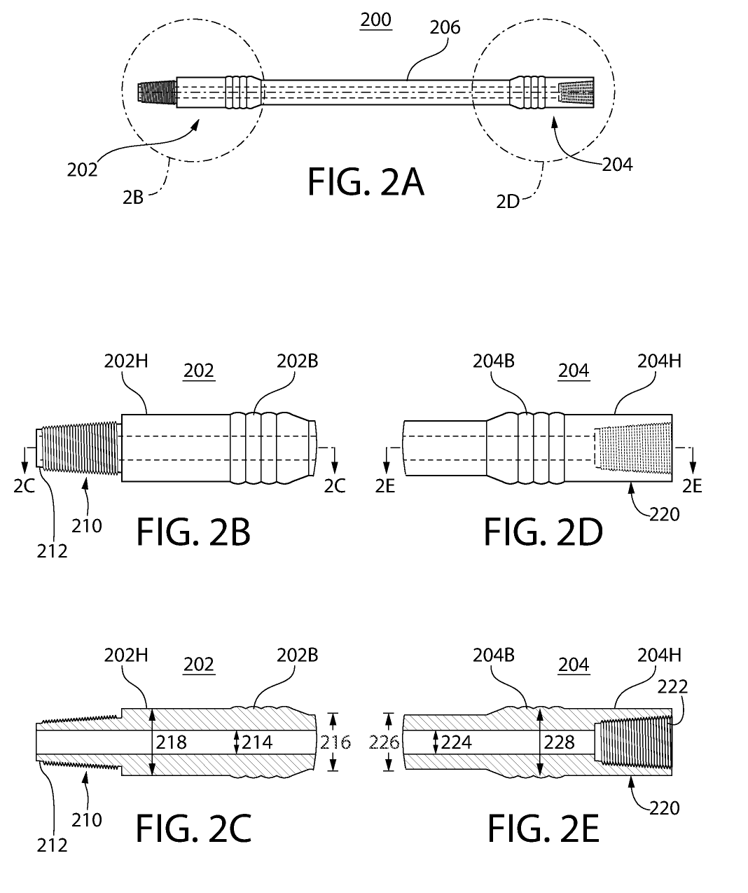

FIG. 2A depicts an example drill pipe 200 with axial hardbanding. As shown, the drill pipe 200 may include a pin end 202, a box end 204, and a shaft 206 that extends between the pin end 202 and the box end 204.

FIG. 2B depicts the pin end 202 of the drill pipe 200 depicted in FIG. 2A. FIG. 2C is a cross-sectional view of the pin end 202 depicted in FIG. 2B. As shown in FIGS. 2B and 2C, the pin end 202 may have a threaded tip 210. The threaded tip 210 may have threading on an exterior surface 212 of the pin end 202.

As shown in FIG. 2C, the pin end 202 may be hollow, and may have a constant inner diameter 214 and a varying outer diameter 216. A portion 202H of the pin end may have a constant outer diameter 218. The pin end 202 of the pipe 200 may include an axial band 202B on an exterior surface of the portion 202H of the pin end 202. An axial banding process as described herein may be employed to apply the axial band 202B to the portion 202H of the pin end 202.

FIG. 2D depicts the box end 204 of the drill pipe 200 depicted in FIG. 2A. FIG. 2E is a cross-sectional view of the box end 204 depicted in FIG. 2D. As shown in FIGS. 2D and 2E, the box end 204 may have a threaded tip 220. The threaded tip 220 may have threading on an interior surface 222 of the box end 204. The threading on the interior surface 222 of the box end tip 220 may be complementary to the threading on the exterior surface 212 of the pin end tip 210, such that the pin end 202 of a first pipe may be screwed into the box end 204 of a complementary second pipe.

As shown in FIG. 2E, the box end 204 may be hollow, and may have a constant inner diameter 224 and a varying outer diameter 226. A portion 204H of the box end 204 may have a constant outer diameter 228. The box end 204 of the pipe 200 may include an axial band 204B on an exterior surface of the portion 204H of the box end 204. An axial banding process as described herein may be employed to apply the axial band 204B to the portion 204H of the box end 204.

In another known process, which may be referred to herein as longitudinal hardbanding, the banding material is applied parallel to the length of the drill pipe. The drill pipe may be in a fixed position while material is added the full length of the area to be banded. The pipe is then rotated to the next position so another length of material can be added parallel to the previous one.

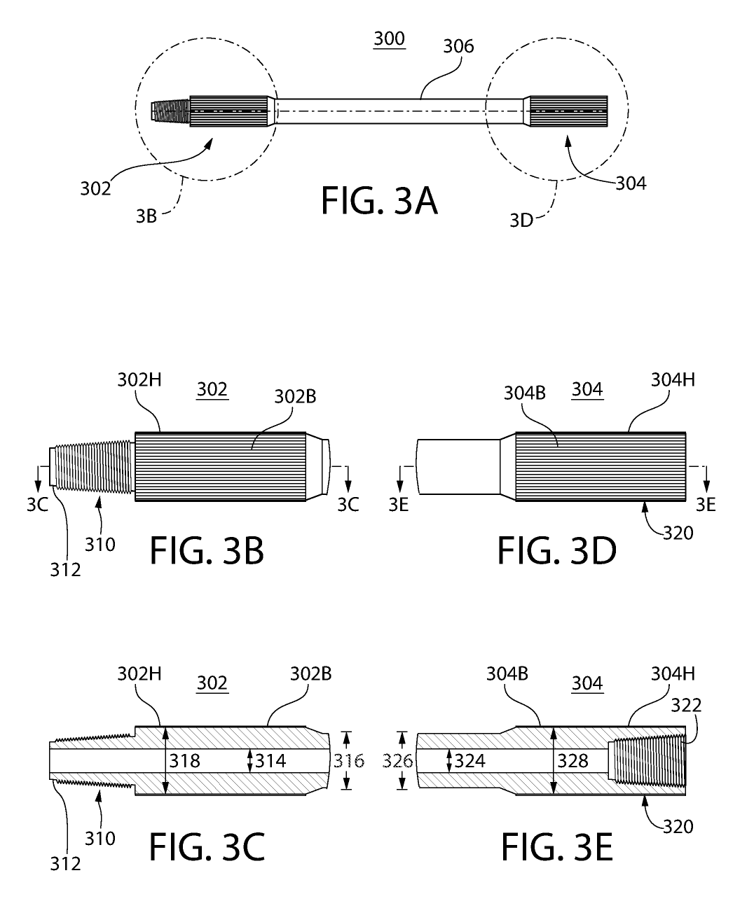

FIG. 3A depicts an example drill pipe 300 with longitudinal hardbanding. As shown, the drill pipe 300 may include a pin end 302, a box end 304, and a shaft 306 that extends between the pin end 302 and the box end 304.

FIG. 3B depicts the pin end 302 of the drill pipe 300 depicted in FIG. 3A. FIG. 3C is a cross-sectional view of the pin end 302 depicted in FIG. 3B. As shown in FIGS. 3B and 3C, the pin end 302 may have a threaded tip 310. The threaded tip 310 may have threading on an exterior surface 312 of the pin end 302.

As shown in FIG. 3C, the pin end 302 may be hollow, and may have a constant inner diameter 314 and a varying outer diameter 316. A portion 302H of the pin end may have a constant outer diameter 318. The pin end 302 of the pipe 300 may include a longitudinal band 302B on an exterior surface of the portion 302H of the pin end 302. A longitudinal banding process as described herein may be employed to apply the longitudinal band 302B to the portion 302H of the pin end 302.

FIG. 3D depicts the box end 304 of the drill pipe 300 depicted in FIG. 3A. FIG. 3E is a cross-sectional view of the box end 304 depicted in FIG. 3D. As shown in FIGS. 3D and 3E, the box end 304 may have a threaded tip 320. The threaded tip 320 may have threading on an interior surface 322 of the box end 304. The threading on the interior surface 322 of the box end tip 320 may be complementary to the threading on the exterior surface 312 of the pin end tip 310, such that the pin end 302 of a first pipe may be screwed into the box end 304 of a complementary second pipe.

As shown in FIG. 3E, the box end 304 may be hollow, and may have a constant inner diameter 324 and a varying outer diameter 326. A portion 304H of the box end 304 may have a constant outer diameter 328. The box end 304 of the pipe 300 may include a longitudinal band 304B on an exterior surface of the portion 304H of the box end 304. A longitudinal banding process as described herein may be employed to apply the longitudinal band 304B to the portion 304H of the box end 304.

A new process, which may be referred to herein as “spiral banding” is disclosed. In spiral banding, material may be applied in one continuous bead that spirals the length of the area to be banded. The spiral band may be a continuous bead of welding material that is deposited on an exterior surface of the pipe, at an angle such that it spirals around a portion of the pipe.

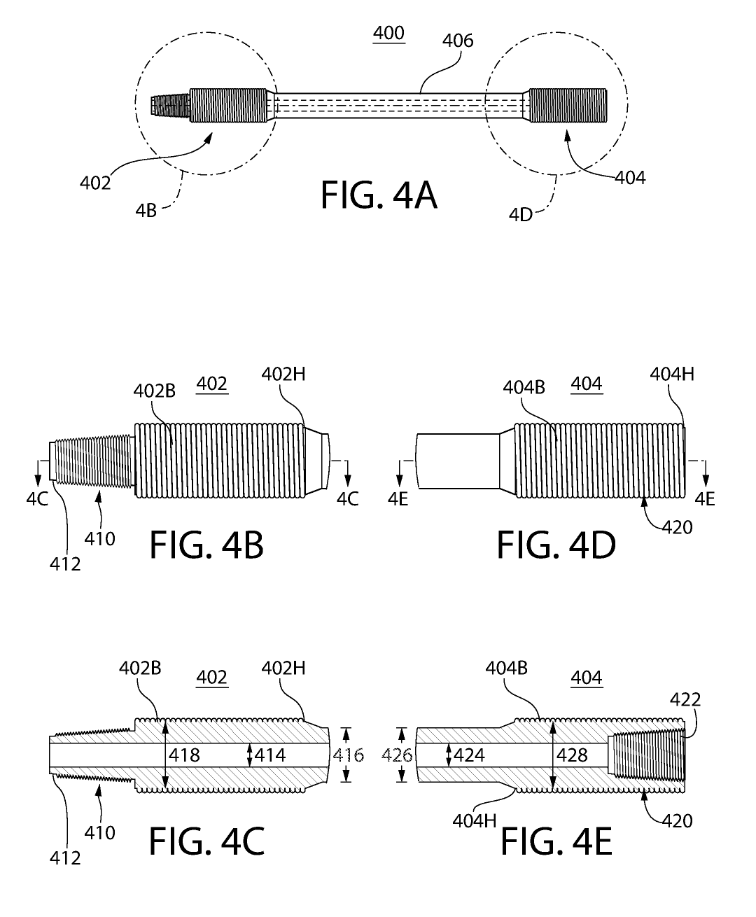

FIG. 4A depicts an example drill pipe 400 with spiral banding. As shown, the drill pipe 400 may include a pin end 402, a box end 404, and a shaft 406 that extends between the pin end 402 and the box end 404.

FIG. 4B depicts the pin end 402 of the drill pipe 400 depicted in FIG. 4A. FIG. 4C is a cross-sectional view of the pin end 402 depicted in FIG. 4B. As shown in FIGS. 4B and 4C, the pin end 402 may have a threaded tip 410. The threaded tip 410 may have threading on an exterior surface 412 of the pin end 402.

As shown in FIG. 4C, the pin end 402 may be hollow, and may have a constant inner diameter 414 and a varying outer diameter 416. A portion 402H of the pin end may have a constant outer diameter 418. The pin end 402 of the pipe 400 may include a spiral band 402B on an exterior surface of the portion 402H of the pin end 402. A spiral banding process as described herein may be employed to apply the spiral band 402B to the portion 402H of the pin end 402.

FIG. 4D depicts the box end 404 of the drill pipe 400 depicted in FIG. 4A. FIG. 4E is a cross-sectional view of the box end 404 depicted in FIG. 4D. As shown in FIGS. 4D and 4E, the box end 404 may have a threaded tip 420. The threaded tip 420 may have threading on an interior surface 422 of the box end 404. The threading on the interior surface 422 of the box end tip 420 may be complementary to the threading on the exterior surface 412 of the pin end tip 410, such that the pin end 402 of a first pipe may be screwed into the box end 404 of a complementary second pipe.

As shown in FIG. 4E, the box end 404 may be hollow, and may have a constant inner diameter 424 and a varying outer diameter 426. A portion 404H of the box end 404 may have a constant outer diameter 428. The box end 404 of the pipe 400 may include a spiral band 404B on an exterior surface of the portion 404H of the box end 404. A spiral banding process as described herein may be employed to apply the spiral band 404B to the portion 404H of the box end 404.

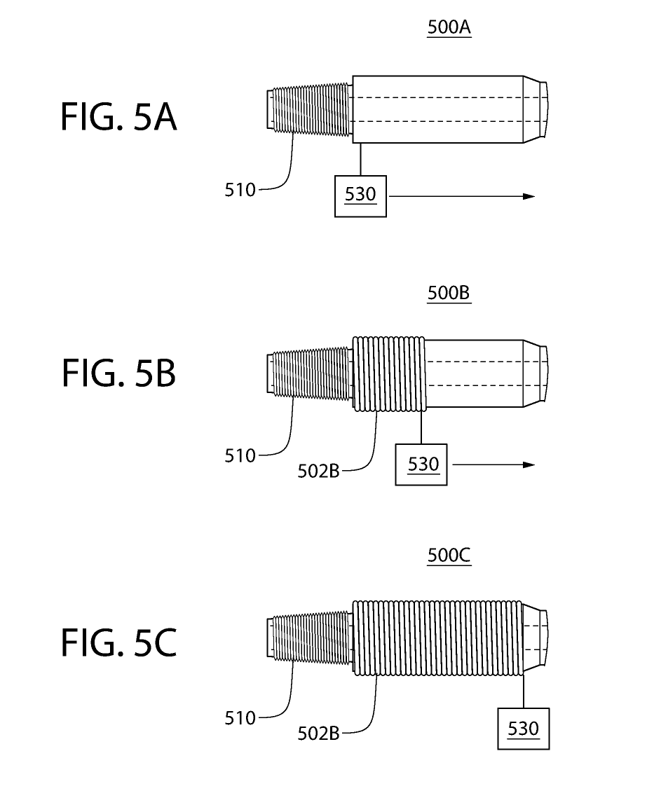

FIGS. 5A-5C illustrate an example apparatus and method for spiral banding the pin end of a drill pipe. It should be understood that the same apparatus and method may be employed for spiral banding the box end of a drill pipe.

As shown in FIG. 5A, a welding electrode 530 is brought within proximity of the pin end 510 of the drill pipe. The drill pipe may be rotated about its longitudinal axis, while at the same time the welding electrode is translated laterally along the length of the drill pipe. As shown in FIGS. 5B and 5C, welding material 502B may thus be deposited on the exterior surface of the drill pipe as a single, continuous bead of welding material, to form a spiral band around the exterior of the drill pipe.

In an example embodiment of spiral banding apparatus, a lathe is modified to turn at a slower rpm. This application uses a standard chuck to hold the workpiece. The workpiece can be attached directly to the chuck or a collar can be adapted to hold the workpiece. The collar may then be mounted to the chuck. A bracket is attached to the carriage portion of the lathe. This bracket holds the welding electrode. As the carriage turns, the electrode travels laterally, applying the weld material to the workpiece. An adjustable limit switch is used to determine the length of the weld.

The drill pipe may be mounted in such a way as to be able to deliver the metal core wire and/or alloys to the desired area and in a fashion that it can be rotated for ease and consistency of application of the material. This may ensure that there is no gap between the base material of the pipe and the spiral band.

In another embodiment, the workpiece is laid on a series of rollers that holds it parallel to the ground. A variable speed motor is attached to a threaded rod. The rod is attached to a roller which rotates the workpiece. As the workpiece rotates, all other rollers move at the same speed as the driven roller. A bracket is attached to the rod which holds the welding electrode. As the rod turns, the electrode advances. Limit switches are used to determine the length of the weld.

In a variation of this embodiment, the bracket that holds the electrode is stationary. The motor is attached to a threaded rod which holds the workpiece. As the motor turns the rod, the workpiece turns and advances. A hydraulic ram is used at the opposite end of the workpiece to apply enough pressure to keep it attached to the rod.

In yet another embodiment, the mount at one end is fixed and a threaded rod runs through it. The workpiece is attached to the threaded rod, which has a collar that holds the external threads of the pin end. A motor attached to the threaded rod allows control of the speed of the rotation, which causes the workpiece to move laterally. The speed and rotation are variable and automated. The other end is fixed to a hydraulic ram that applies pressure to the shaft, keeping it from detaching from the tool. The welding electrode is attached to a stationary bracket and applies the weld material as the workpiece travels. Again, limit switches are used to determine the length of the weld.

In another embodiment, the workpiece may be attached to a tool that uses collets that expand to grip the inside diameter of the tube. The tool is attached to gearbox. A variable speed motor is attached to the gearbox. The rotation of the tool also drives a pulley connected to a threaded rod. The welding electrode is attached to a bracket which is attached to the rod moving it laterally. Limit switches are used to determine the length of the weld. This embodiment allows for better control of the grounding of the welding equipment.

The mount of the electrode may be offset from top center, towards the rotation of the workpiece. This allows the molten alloys to cool in the precise place applied and to avoid “dripping” or “running” of material. There may be mounts at both the box end and the pin end. The mounts may be mounted at identical angles. The mount angle can range from 0-20 degrees, for example.

Apparatus and methods are disclosed for applying material to a workpiece, such as a drill pipe. The drill pipe may have a tool joint that includes a box end having female threads and a pin end having male threads. The material may be applied as a continuous bead forming a spiral pattern on the workpiece. The material may be applied through the use of welding techniques. The material may be applied to an exterior surface of either the box end or the pin end of the tool joint, or the exterior or interior threads of either the box end or the pin end of the tool joint.

The workpiece may be mounted to a fixed structure. For example, the workpiece may be mounted to a standard chuck in a lathe. The workpiece may be attached directly or indirectly to the chuck. A welding electrode may be mounted to the structure. A modified bracket may be used. The bracket may be mounted to the carriage of a lathe and may be perpendicular to top-center of the workpiece. The bracket may be duplicated at the box end and pin end of the workpiece, and mounted in a fashion to hold the electrode above the workpiece. A collar may be mounted in the bracket to hold the welding electrode. The collar may be offset from top center from 0-20 degrees, pointing towards the rotation of the workpiece.

The workpiece may be laid on rollers to facilitate the rotation of the workpiece. The rotation of the workpiece may be achieved by a motor driving one of the rollers. The motor may use a variable speed controller. The motor may drive one of the rollers, causing all rollers that come in contact with the workpiece to roll at the same speed of rotation. A threaded rod may be attached to one of the rollers and travel through a bracket that is perpendicular to top-center of the workpiece. The bracket may be duplicated at the box end and pin end of the workpiece, and mounted in a fashion to hold the electrode above the workpiece.

An end of the workpiece may be attached to a collar that is attached to a threaded rod. A motor with a variable speed controller may be used to turn the threaded rod. The threaded rod may travel through a nut that is fixed to the structure, allowing the workpiece to travel laterally. The opposite end of the workpiece may be friction-mounted to a hydraulic ram. The ram may use variable pressure to hold the workpiece in place.

A bracket may be used for the mounting of a welding electrode. The bracket may be perpendicular to top-center of the workpiece. The bracket may be duplicated at the box end and pin end of the workpiece, and mounted in a fashion to hold the electrode above the workpiece. A collar may be mounted in the bracket to hold the welding electrode. The collar may be offset from top center from 0-20 degrees, pointing towards the rotation of the workpiece.

One end of the workpiece may be mounted to a collar attached to a threaded rod. The threaded rod may travel through a stationary bracket, allowing it to move the workpiece laterally. The threaded rod may be mounted to a motor with a variable speed controller to spin the rod, causing it to travel through the stationary bracket. The opposite end of the workpiece may be friction-mounted to a hydraulic ram. The ram may use variable pressure to keep the workpiece in place on the structure.

An end of the workpiece may be mounted to the tool using expanding collets to hold it in place. The collets may be mounted to a motor with a variable speed controller.

The motor may drive a series of belts which turn a nut, moving a threaded rod. The threaded rod may travel through a stationary bracket. That bracket may be perpendicular to top-center of the workpiece and mounted in a fashion to hold the electrode above the workpiece. The mounting bracket may be moved to facilitate reconditioning of the threads at either box or pin end.

1. A spiral-banded drill pipe, comprising:
a pin end, a box end, and a shaft that extends between the pin end and the box end, and
a continuous bead of welding material that is deposited on an exterior surface of the pin end, and spirals around a portion of the pin end.

2. The drill pipe of claim 1, wherein the pin end is hollow and has a constant inner diameter, and wherein the portion of the pin end onto which the bead is deposited has a constant outer diameter.

3. The drill pipe of claim 1, wherein the pin end has a threaded tip having threading on an exterior surface of the pin end.

4. The drill pipe of claim 3, wherein the bead is deposited on an exterior surface of a portion of the pin end that is adjacent to the threaded tip of the pin end.

5. The drill pipe of claim 1, wherein the box end has a threaded tip having threading on an interior surface of the box end.

6. The drill pipe of claim 5, wherein the threading on the interior surface of the box end is complementary to the threading on the exterior surface of the pin end.

7. The drill pipe of claim 5, further comprising a second continuous bead of welding material deposited on an exterior surface of the box end.

8. The drill pipe of claim 7, the portion of the box end onto which the bead is deposited has a constant outer diameter.

9. A spiral-banded drill pipe, comprising:
a pin end, a box end, and a shaft that extends between the pin end and the box end, and
a continuous bead of welding material that is deposited on an exterior surface of the box end, and spirals around a portion of the box end.

10. The drill pipe of claim 9, wherein the box end has a threaded tip having threading on an interior surface of the box end.

11. The drill pipe of claim 9, wherein the box end is hollow and the welding material is is deposited on an exterior surface of a portion of the box end that has a constant outer diameter.

12. The drill pipe of claim 9, wherein the pin end has a threaded tip having threading on an exterior surface of the pin end.

13. The drill pipe of claim 12, further comprising a second continuous bead of welding material deposited on an exterior surface of the pin end.

14. The drill pipe of claim 13, wherein the second bead is deposited on an exterior surface of a portion of the pin end that is adjacent to the threaded tip of the pin end.

15. The drill pipe of claim 13, wherein the pin end is hollow and has a constant inner diameter, and wherein the second bead is deposited on an exterior surface of a portion of the pin end that has a constant outer diameter.

16. The drill pipe of claim 15, wherein the threading on the interior surface of the box end is complementary to the threading on the exterior surface of the pin end.

17. A spiral-banded drill pipe, comprising:
a pin end having a threaded tip, wherein the threaded tip of the pin end includes threading on an exterior surface of the pin end;
a box end having a threaded tip, wherein the threaded tip of the box end includes threading on an interior surface of the box end;
a shaft that extends between the pin end and the box end;
a first spiral band of welding material deposited on an exterior surface of the pin end; and
a second spiral band of welding material deposited on an exterior surface of the box end.

18. The drill pipe of claim 17, wherein the pin end is hollow, and wherein the first spiral band is deposited on an exterior surface of a portion of the pin end that has a constant outer diameter.

19. The drill pipe of claim 18, wherein the box end is hollow, and wherein the second spiral band is deposited on an exterior surface of a portion of the box end that has a constant outer diameter.

20. The drill pipe of claim 19, wherein the pin end has a threaded tip having threading on an exterior surface of the pin end, the box end has a threaded tip having threading on an interior surface of the box end, and wherein the threading on the interior surface of the box end is complementary to the threading on the exterior surface of the pin end.
